(19) United States
(12) Patent Application Publication
(10) Pub. No.: US 2013/0265395 A1
(43) Pub. Date: Oct. 10, 2013

(54) System and Method for Generation of Stereo Imagery

(71) Applicants: John D. Vala, Plymouth, MI (US); David D. Conger, Grosse Pointe Woods, MI (US); John-Taylor W. Smith, Martinsville, IN (US)

(72) Inventors: John D. Vala, Plymouth, MI (US); David D. Conger, Grosse Pointe Woods, MI (US); John-Taylor W. Smith, Martinsville, IN (US)

(21) Appl. No.: 13/443,397

(22) Filed: Apr. 10, 2012

(51) Int. Cl. H04N 13/02

(52) U.S. Cl. 348/47; 348/E13.074

(57) ABSTRACT

A system for generation of stereo video imagery. The system includes a first video camera, a second video camera, and an analysis subsystem. Positioning of the first and second video cameras is dynamically adjusted in near real time in response to a control signal that is generated by the analysis subsystem in response to the difference between a disparity signal and a reference parallax signal to dynamically minimize the difference between the disparity signal and the reference parallax signal.

### GOVERNMENT INTEREST

The invention described here may be made, used and licensed by and for the U.S. Government for governmental purposes without paying royalty to us.

### BACKGROUND OF THE INVENTION

1. Field of the Invention

The present invention generally relates to a system and a method for generation of stereo imagery.

2. Background Art

Conventional systems and methods for generation of stereo video imagery may have a number of deficiencies. Among the deficiencies of conventional stereo imagery generation are excessive technicalities, slow operations, extensive, time consuming manual (i.e., camera operator, director, or the like) input, and generation of imagery that is unsatisfactory (i.e., inaccurate, causes viewer discomfort such as induced eye strain, headache, and symptoms of nausea, and the like). Conventional systems and methods for generation of stereo imagery typically are implemented having the operator make camera spacing adjustments and then view the preliminary results prior to capturing the final work. This is laborious, time consuming, and risks inconsistencies in the results.

Workers in the field of conventional stereoscopic video imaging have used typically either rules-of-thumb calculations (the 1/30 rule), or specific formulas requiring values for camera lens information and distances to various objects in the field of view, or subjective interpretation of the image to adjust the spacing between two stereoscopic cameras for image capture. The numerous variables affecting the parameters of the calculations and the individual subjective factors of the worker lead to a wide variety of both good and poor results. In the conventional three dimensional (3D) film-making industry, improper spacing of the recording cameras has caused many films that induce eye strain, headache, and symptoms of nausea in the movie goers (i.e., viewers).

Thus, there exists a need and an opportunity for an improved system and method for generation of stereo imagery. Such an improved system and method may overcome one or more of the deficiencies of the conventional approaches.

### SUMMARY OF THE INVENTION

Accordingly, the present invention may provide an improved system and method for generation of stereo imagery.

According to the present invention, a system for generation of stereo video imagery is provided. The system includes: a first video camera that generates and presents a first video image signal and having a first optical axis, and a second video camera that generates and presents a second video image signal and having a second optical axis; an analysis subsystem that receives the first and second video image signals, and generates and presents a control signal; a mounting rail; and an electromechanical adjustment subsystem that receives the control signal. The first and second video cameras are electromechanically coupled to the mounting rail and the adjustment subsystem such that the first optical axis and the second optical axis are substantially parallel, and lateral positioning of the first and second video cameras on the rail is dynamically adjusted via the electromechanical adjustment subsystem in response to the control signal. The analysis subsystem comprises a disparity map generator, a reference block that presents a reference parallax signal, and a comparator having a first comparator input and a second comparator input and a comparator output; and the disparity map generator receives the first and second video image signals and generates a disparity signal in response to the first and second video image signals and presents the disparity signal to the first comparator input; and the comparator receives the reference parallax signal at the second comparator input, generates the control signal in response to the difference between the disparity signal and the reference parallax signal, and presents the control signal via the comparator output to the electromechanical adjustment subsystem in near real time to dynamically minimize the difference between the disparity signal and the reference parallax signal.

The system further includes a stereoscopic video display device that receives the first and second video image signals, and presents a stereoscopic video image to a viewer.

The first and second video cameras are electromechanically coupled to the mounting rail and the adjustment subsystem such that desired scenery is viewed substantially simultaneously, with the same magnification, field of view, and temporal synchronization.

The electromechanical adjustment subsystem provides lateral translation of the first and second video cameras in response to the control signal to adjust the spacing between the first and second video cameras without effect on parallel alignment of the first and second optical axes.

The electromechanical adjustment subsystem further provides rotation of the first and second video cameras in response to the control signal to adjust the horizontal angular subtense between the first and second video cameras.

The disparity map generator may be implemented as a sliding window, block matching stereo correspondence algorithm that determines the disparity signal as a single representative value.

The reference block includes a computer memory that stores and presents one or more of the reference parallax signal.

Also according to the present invention, a method of generating stereo video imagery is provided. The method includes the steps of: electromechanically coupling: a first video camera that generates and presents a first video image signal and having a first optical axis, and a second video camera that generates and presents a second video image signal and having a second optical axis; wherein, the first optical axis and the second optical axis are substantially parallel; an analysis subsystem that receives the first and second video image signals, and generates and presents a control signal; a mounting rail; and an electromechanical adjustment subsystem that receives the control signal; and adjusting lateral positioning of the first and second video cameras on the rail dynamically via the electromechanical adjustment subsystem in response to the control signal.

The analysis subsystem includes a disparity map generator, a reference block that presents a reference parallax signal, and a comparator having a first comparator input and a second comparator input and a comparator output; and the disparity map generator receives the first and second video image signals and generates a disparity signal in response to the first and second video image signals and presents the disparity signal to the first comparator input; and the comparator receives the reference parallax signal at the second comparator input, generates the control signal in response to the difference between the disparity signal and the reference parallax signal, and presents the control signal via the comparator output to the electromechanical adjustment subsystem in near real time to dynamically minimize the difference between the disparity signal and the reference parallax signal.

The method further includes electrically coupling to the first and second video cameras a stereoscopic video display device that receives the first and second video image signals, and presents a stereoscopic video image to a viewer in response to the first and second video image signals.

The first and second video cameras are electromechanically coupled to the mounting rail and the adjustment subsystem such that desired scenery is viewed substantially simultaneously, with the same magnification, field of view, and temporal synchronization.

The electromechanical adjustment subsystem provides lateral translation of the first and second video cameras in response to the control signal to adjust the spacing between the first and second video cameras without effect on parallel alignment of the first and second optical axes.

The electromechanical adjustment subsystem further provides rotation of the first and second video cameras in response to the control signal to adjust the horizontal angular subtense between the first and second video cameras.

The disparity map generator may be implemented as a sliding window, block matching stereo correspondence algorithm that determines the disparity signal as a single representative value.

The reference block comprises a computer memory that stores and presents one or more of the reference parallax signal.

Further, according to the present invention, an analysis system for controlling generation of stereo video imagery is provided. The system includes: a disparity map generator; a reference block that presents a reference parallax signal; and a comparator having a first comparator input and a second comparator input and a comparator output.

The disparity map generator receives a first video image signal that is generated and presented by a first video camera having a first optical axis and a second video image signal that is generated and presented by a second video camera and having a second optical axis; and generates a disparity signal in response to the first and second video image signals and presents the disparity signal to the first comparator input; and the comparator receives the reference parallax signal at the second comparator input, generates a control signal in response to the difference between the disparity signal and the reference parallax signal, and presents the control signal via the comparator output to an electromechanical adjustment subsystem.

The first and second video cameras are electromechanically coupled to a mounting rail and the electromechanical adjustment subsystem such that the first optical axis and the second optical axis are substantially parallel, and lateral positioning of the first and second video cameras on the rail is adjusted via the electromechanical adjustment subsystem in response to the control signal in near real time to dynamically minimize the difference between the disparity signal and the reference parallax signal.

The first and second video cameras are electromechanically coupled to the mounting rail and the adjustment subsystem such that the first and second video image signals are generated substantially simultaneously, with the same magnification, field of view, and temporal synchronization.

The electromechanical adjustment subsystem provides lateral translation of the first and second video cameras in response to the control signal to adjust the spacing between the first and second video cameras without effect on parallel alignment of the first and second optical axes.

The electromechanical adjustment subsystem further provides rotation of the first and second video cameras in response to the control signal to adjust the horizontal angular subtense between the first and second video cameras.

The disparity map generator may be implemented as a sliding window, block matching stereo correspondence algorithm that determines the disparity signal as a single representative value.

The reference block includes a computer memory that stores and presents one or more of the reference parallax signal.

The above features, and other features and advantages of the present invention are readily apparent from the following detailed descriptions thereof when taken in connection with the accompanying drawings.

### BRIEF DESCRIPTION OF THE DRAWINGS

FIG. 1 is a diagram of a stereo imagery generation system;

FIG. 2 is a diagram of illustrations of left camera, right camera, and fused stereo imagery, as generated via the system of FIG. 1;

FIG. 3 is a more detailed block schematic diagram of the stereo imagery system of FIG. 1;

FIGS. 4(A-B) are illustrations of left camera and right camera images as generated via the system of FIGS. 1 and 3 when the separation of the left camera and right camera is at a first distance, and FIG. 4C is an illustration of a disparity map generated from the camera images of FIGS. 4(A-B); and

FIG. 5 is an illustration of a disparity map generated from camera images generated similarly to the images of FIGS. 4(A-B) when the separation of the left camera and right camera is at a second distance.

### DETAILED DESCRIPTION OF THE PREFERRED EMBODIMENT(S)

### Definitions and Terminology

The following definitions and terminology are applied as understood by one skilled in the appropriate art.

The singular forms such as a, an, and the include plural references unless the context clearly indicates otherwise. For example, reference to a material includes reference to one or more of such materials, and an element includes reference to one or more of such elements.

As used herein, substantial and about, when used in reference to a quantity or amount of a material, characteristic, parameter, and the like, refer to an amount that is sufficient to provide an effect that the material or characteristic was intended to provide as understood by one skilled in the art. The amount of variation generally depends on the specific implementation. Similarly, substantially free of or the like refers to the lack of an identified composition, characteristic, or property. Particularly, assemblies that are identified as being substantially free of are either completely absent of the characteristic, or the characteristic is present only in values which are small enough that no meaningful effect on the desired results is generated.

A plurality of items, structural elements, compositional elements, materials, subassemblies, and the like may be presented in a common list or table for convenience. However, these lists or tables should be construed as though each member of the list is individually identified as a separate and unique member. As such, no individual member of such list should be considered a de facto equivalent of any other member of the same list solely based on the presentation in a common group so specifically described.

Concentrations, values, dimensions, amounts, and other quantitative data may be presented herein in a range format. One skilled in the art will understand that such range format is used for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a size range of about 1 dimensional unit to about 100 dimensional units should be interpreted to include not only the explicitly recited limits, but also to include individual sizes such as 2 dimensional units, 3 dimensional units, 10 dimensional units, and the like; and sub-ranges such as 10 dimensional units to 50 dimensional units, 20 dimensional units to 100 dimensional units, and the like.

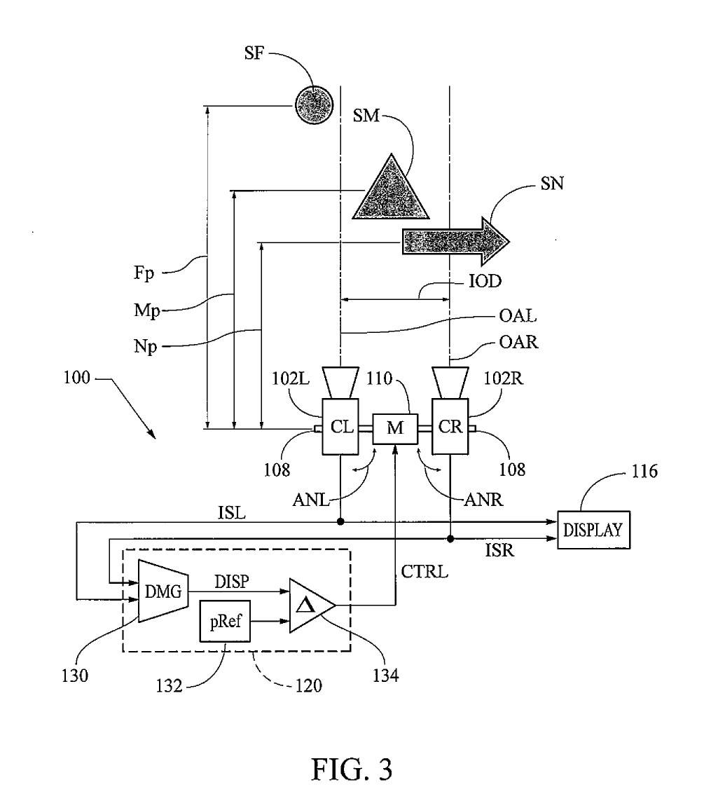

The description as follows includes directional designations such as up, down, left, right, lateral, transverse, axial, longitudinal, top, bottom, vertical, and the like, that are taken from the perspective of a video camera system as typically held or mounted and operated by a typical user. As such, lateral (left/right) directions (see, for example, FIG. 3) are generally perpendicular to the longitudinal/vertical plane.

As used herein, the following terms may be defined as would be understood by one having ordinary skill in the art:

Disparity: Specifically, binocular disparity generally refers to the difference in image location of an object seen by the left and right eyes via binocular viewing. Disparity is caused by the horizontal separation of the eyes of the viewer. The viewer uses binocular disparity to derive depth information from the two-dimensional retinal images (see below, Stereopsis). In computer generated and analyzed stereo imagery, binocular disparity refers to the difference in coordinates of corresponding features when two stereo images are compared.

Near real time: A time that is very close to simultaneous (e.g., real time); generally limited by the time taken for relatively temporally short or mechanically small movements of electromechanical mechanisms in response to control signals.

Parallax: A displacement or difference in the apparent position of an object viewed along two different lines of sight, and is generally measured by the angle or semi-angle of inclination between those two lines (see below, Subtense). Objects closer to the cameras (or eyes) will produce a greater parallax, while objects that are farther away will produce less parallax.

Stereopsis: Stereoscopic vision. That is, the impression of depth that is perceived by a viewer when an image is viewed using both eyes with normal binocular vision.

Subtense: A line which subtends, especially the chord of an arc. The angle subtended by a line at a point.

With reference to the Figures, the preferred embodiments of the present invention will now be described in detail. Generally, the present invention provides an improved system and an improved method for stereoscopic imagery generation. Such a system and method may be advantageously implemented in connection with any task where stereoscopic imagery generation is desired.

Proper camera spacing is generally desirable to achieve the desired visualization (e.g., accurately generated imagery) of scene. An improved system and an improved method for stereoscopic imagery generation described herein generally implement: (a) determination of camera spacing by consideration of all subject elements within field of view of each of the cameras; (b) the consideration of the optical system of the cameras; and (c) both the subjective and objective tolerance of human stereopsis.

The system and method of stereo imagery generation described herein is generally directed to providing high fidelity visual appearance of stereoscopic content presented to a person viewing the stereoscopic imagery by dynamically adjusting the separation between the two (i.e., stereo) cameras initially capturing the features (content) of the image in substantially near real time. By continuously updating the spacing between the two cameras in near real time, as determined by a disparity map generated from images of the objects within the field of view of the cameras, the user (e.g., camera operator, director, and the like) is free to concentrate their attention on the composition of the imagery instead of the technicalities of the stereoscopic process as is typically done in conventional stereoscopic imagery generation.

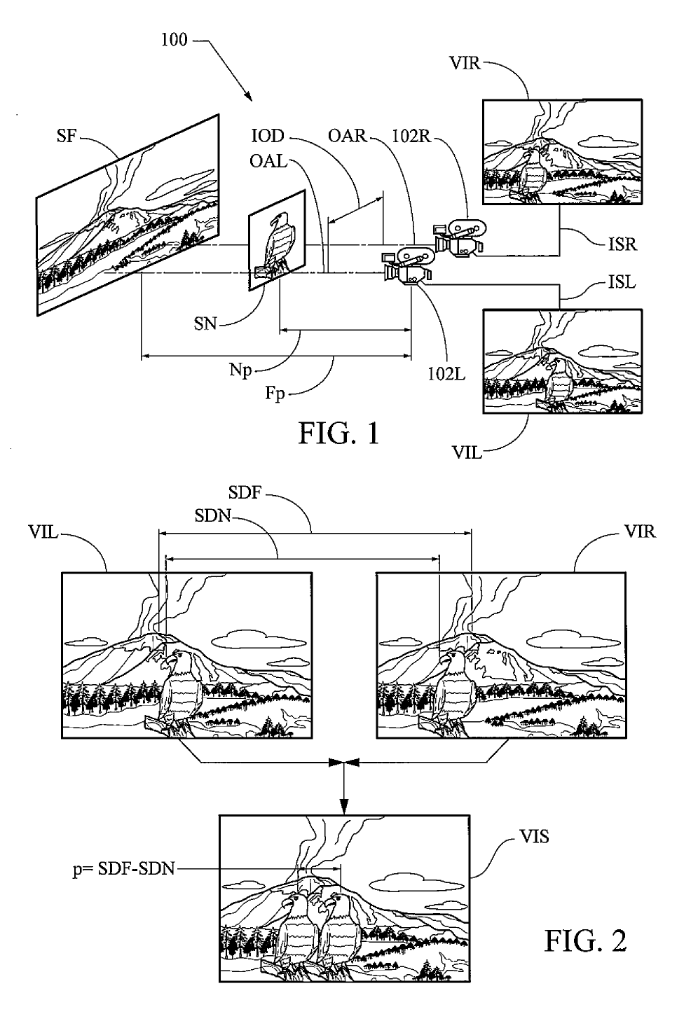

As described in more detail below with reference to FIGS. 1-5, the process (method, steps, etc.) of filming or recording (i.e., generating a stereoscopic image) a stereoscopic scene (e.g., the scenes of FIGS. 1, 2, and 4(A-B)) involves a configuration of two substantially identical camera sub-systems having respective optical axes that are substantially parallel and separated by a specific lateral distance (i.e., inter-ocular distance). The distance of camera separation generally results in the generation of two slightly different images in each of the camera image planes similar to the two separate images received by the brain of the viewer as caused by the separation of eyes in binocular viewing.

The distance between near and far objects within the field of view of the cameras produce slight variations in the resulting positions of the image of those objects in each image plane within the cameras. The slight difference between the relative positions of corresponding objects in each of the two images is defined as parallax or disparity (see Glossary, above). When reproduced in a stereoscopic imaging system, the human visual system can accommodate a limited amount of parallax to reproduce human depth perception, and so, can only tolerate a specific amount of camera lens separation depending on the relative distance between the cameras, and the closest and farthest objects within the field of view. Video imagery signals from the left and right stereo camera pairs are simultaneously sent to the stereo display or recording system and are monitored by a disparity map generator algorithm which calculates the amount of disparity and/or parallax between the two images.

The present invention provides a method to adjust the distance between the two cameras based on the measured parallax between objects within the two images. The measured parallax and, thus, disparity can be determined (i.e., calculated, generated) by the results of a mathematical calculation plot called a disparity map which implements an image processing algorithm. By generating a disparity map from the left and right images in near real time, and controlling the measured disparity to a predetermined value by adjustment of the camera separation, improved visual appearance of the stereoscopic content will generally result. The values plotted within the disparity map are generally implemented to provide a feedback signal that controls a motorized mechanism for the positioning of the camera spacing and/or angular orientation.

Referring to FIG. 1, a stereo imagery generation system (i.e., apparatus, assembly, opto-electromechanical arrangement, and the like) 100 is shown. The system 100 generally comprises a pair of video or similar cameras 102 (e.g., left camera 102L and right camera 102R), each having an optical axis, (e.g., left optical axis, OAL, and right optical axis, OAR). The cameras 102 are generally mutually positioned such that the optical axes, OAL and OAR, are substantially parallel and aligned to view the desired scenery substantially simultaneously, and with the same magnification, range, field of view, and temporal synchronization. The optical axes OAL and OAR, are generally separated by a lateral distance (e.g., inter-ocular distance, inter-camera distance), IOD.

During operation, the left camera 102L may generate a video image signal (e.g., a signal, ISL); and the right camera 102R may generate a video image signal (e.g., signal, ISR). The video signal ISL may cause a video display device to generate (e.g., produce) a left video image, VIL; and the video signal ISR may cause a video display device generate a right video image, VIR, in connection with a video imagery processing sub-system (described in more detail in connection with FIGS. 2-5).

As illustrated on FIG. 1, a desired overall scene may include a near scene (e.g., a scene, SN) shown illustrating near object (e.g., a bird), and having a position Near Point (distance), Np, from the cameras 102; and a far scene (e.g., a scene, SF) shown illustrating a far object (e.g., a mountain), and having a position Far Point (distance), Fp, from the cameras 102.

As illustrated on FIG. 3, the overall scene may further include a middle (i.i., intermediate) distance scene (e.g., a scene, SM) illustrating an object (e.g., a triangle) that is at a distance, Mp, from the cameras 102 and is between the objects at the near distance, Np, (e.g., an arrow) and at the far position distance, Fp, (e.g., a circle).

The optical axes OAL and OAR, generally extend longitudinally (axially) from the cameras 102 to the scenes, SF and SN (as well as including the scene, SM, on FIG. 3). Comparing the right camera image, ISR, with the left camera image, ISL, the relative difference in the positions of the near object with respect to the far object between the images ISL and ISR is generally due to the difference in parallax between the positions of the cameras 102 relative to the distances, Np and Fp. (Described in more detail in connection with FIG. 2).

Referring to FIG. 2, an exemplary illustration of parallax is shown. The upper portion of FIG. 2 includes the left video image, VIL, and the right video image, VIR. The lower portion of FIG. 2 includes a superposition (e.g., fusion) video image, VIS, that may be generated by fusion of the images VIL and VIR. Fusion of video images may be accomplished by any suitable apparatus and method as would be understood by one having ordinary skill in the art.

As illustrated on the upper portion of FIG. 2, the far scene, SF, in the videos images VIL and VIR may be separated by a distance, SDF; and, the near scene, SN, in the videos images VIL and VIR may be separated by a distance, SDN. As illustrated on the lower portion of FIG. 2, the superposition video image, VIS, generally displays the difference in the object (e.g., the bird) on the near scene, SN, as the resultant parallax, p. That is, p=SDF−SDN. Objects closer to the cameras 102 will generally produce a greater parallax, p, while objects farther away will produce less parallax. As such, differences in perceived parallax between each object will result in a perceived difference in depth between the objects.

The relative difference between the images of the same object in the left and right images (e.g., the bird in the images, VIL and VIR), results in the measured parallax, p, for the fusion scene image, VIS. As is understood in the art, when the parallax, p, is not excessive, a person viewing the reconstructed stereoscopic image pair, VIL and VIR, will generally perceive a comfortable (i.e., as understood from studies, experimentation, and other research, less likely to cause headache, nausea, and/or other discomfort when viewed by a typical user) difference in depth between the near and far objects, i.e., the scenes SF and SN will be displayed as images that are substantially accurate reproductions of what is normally viewed via binocular vision.

Image pairs that have less parallax than what is accurate will generally appear more flat and with less depth than normal, and image pairs having more parallax than what is accurate may induce eyestrain and eventually nausea in the viewer. The system 100 generally provides the stereoscopic image pair signals, VIL and VIR, to generate in any stereoscopic image such that the parallax within the stereoscopic image, VIS, as viewed generally has perception of the depth within a range of accuracy, pRef, that does not induce eyestrain, headache, and/or nausea. (See also, FIG. 3 and related description below). Such a range of parallax accuracy, pRef, so as not to be excessive would be understood by one having ordinary skill in the art.

Referring again to FIG. 3, a more detailed block diagram of the opto-electromechanical system 100 is shown. The system 100 generally comprises the pair of video cameras (i.e., the left camera, CL, 102L; and the right camera, CR, 102R), a mounting bar (e.g., beam, rail, and the like) 108, a motorized actuation (adjustment) subsystem (M) 110, a video display device 116, and an analysis subsystem (e.g., system, group, device, apparatus, etc.) 120.

The cameras 102 are generally mechanically coupled to (i.e., installed on, hooked up with, connected to, etc.) the mounting bar 108 and the adjustment subsystem 110. The adjustment subsystem 110 generally includes one or more motors, power and control circuitry, electromechanical drive mechanisms, gear boxes, gimbals, actuators, sensors, switches, servos, linkages, and the like.

The adjustment subsystem 110 generally provides rapid (i.e., near real time), precise translation of cameras 102 to adjust the side-to-side spacing between the two cameras 102 (i.e., modification of the inter-camera distance, IOD) without effect on the parallel alignment of the optical axes, OAL and OAR, of camera systems 102. The adjustment subsystem 110 may also comprise one or more additional motors and/or actuation mechanisms attached to the camera 102 system to provide rapid, precise rotation of the cameras 102 to adjust the horizontal angular subtense between the two cameras 102 (e.g., angular rotation, ANL, for the camera CL, 102L, and angular rotation, ANR, for the camera CR, 102R) without effect on the vertical angular alignment of the optical axis of camera 102 systems to adjust disparity as an alternative to, and/or in addition to, lateral shifting of the cameras 102. As is known and appreciated in the art, a number of closed loop position control electromechanical subsystems may be implemented as the adjustment subsystem 110.

The cameras 102 are generally electrically coupled to the display device 116 and the analysis subsystem 120. The cameras 102 are generally electrically coupled to a video recording apparatus (for clarity of explanation, not shown) such that the desired imagery may be recorded. The adjustment subsystem 110 may be electrically coupled to the analysis subsystem 120. The video display device 116 is generally implemented as a dual (i.e., left and right) video display apparatus that is suitable for stereo image viewing, as understood in the art. The left camera 102L may present the left video image signal, ISL, to the display device 116 and to the analysis system 120; and the right camera 102R may present the right video image signal, ISR, to the display device 116 and to the analysis system 120.

The analysis system 120 may present a feedback control signal (e.g., control signal, error signal, CTRL) to the adjustment subsystem 110. The analysis system 120 may generate the control signal, CTRL, in response to the left video image signal, ISL, the right video image signal, ISR, and one or more additional signals as described below. The adjustment subsystem 110 may adjust the lateral camera spacing, IOD, between the two cameras 102 in response to the feedback signal, CTRL. The adjustment subsystem 110 may also adjust the angular rotation, ANL, and the angular rotation, ANR, in response to the feedback signal, CTRL.

The analysis system 120 generally comprises a disparity map generator (DMG) 130, a reference block 132, and a comparator (delta) 134. The DMG 130, the reference block 132, and the comparator 134 are generally electrically coupled. The DMG 130, the reference block (e.g., look up table, and the like) 132, and the comparator 134 may be implemented in software, hardware, firmware, and the like. The DMG 130, the reference block 132, and the comparator 134 are generally implemented in connection with and coupled to a computer processing system including memory. The implementation of such a computer system is well known in the art and, thus, not illustrated for clarity.

The DMG 130 may receive the left video image signal, ISL, and the right video image signal, ISR, at first and second generator inputs, and may generate a disparity value signal (e.g., DISP). The reference block 132 generally includes one or more reference parallax values (e.g., the reference parallax signal, pRef) that may be presented as signals for comparison with the disparity value signals, DISP, that are generated substantially continuously by the DMG 130. The DMG 130 may present the disparity value, DISP, to a first input of the comparator 134; and the reference block 132 may present a reference value (e.g., the reference signal, pRef) to a second input of the comparator 134. The comparator 134 may generate the feedback control signal, CTRL, in response to the difference between the signals DISP and pRef. The reference signal, pRef, generally comprises a range of values of parallax that are known in the art to provide acceptable stereo viewing when displayed to a viewer having normal binocular vision on a conventional stereoscopic video display apparatus (e.g., the display 116).

The DMG 130 comprises a computer algorithm that receives the video or still imagery from the left and right cameras 102 (i.e., the video signals ISL and ISR); performs a comparison between the two images to determine the property of disparity present between the images. The result of the calculation (i.e., the signal, DISP) is generally a single representative value of the greatest amount of disparity measured from all of the values calculated over the entire image set that originates from the video signals ISL and ISR. As understood by one of ordinary skill in the art, there are a number of disparity map generator algorithms that may be implemented to perform the desired calculation.

In a preferred embodiment of the system 100, the disparity map generator algorithm 130 may be implemented as a sliding window, block matching stereo correspondence algorithm. Block matching stereo correspondence algorithms are typically relatively fast (e.g., computationally efficient) when compared to some alternative disparity map generation algorithms. Block matching stereo correspondence algorithms are generally implemented as a one-pass stereo matching algorithm that uses sliding sums of absolute differences between pixels in the left image and the pixels in the right image, shifted by a chosen (i.e., predetermined) varying amount of pixels. On a pair of images (e.g., Width (W) in pixels×Height (H) in pixels, the algorithm computes disparity in (W*H*number of disparities) time.

As understood in the art, to improve quality and readability of the generated disparity map, the block matching stereo correspondence algorithm generally includes pre-filtering and post-filtering procedures (for clarity, not shown). The block matching stereo correspondence algorithm searches for the corresponding blocks in a single direction only. As such, the supplied stereo pair of signals is generally rectified. Vertical stereo layout may be accommodated when the images are transposed by the user.

An alternative disparity map generation algorithm that may be implemented as the generator 130 to compute disparities uses graph cuts. A graph may be generated from two images and then cut in such a way as to minimize the energy that results from depth discontinuities in the image.

However, any appropriate disparity map generation algorithm may be implemented as the DMG 130 to meet the design criteria of a particular application. As such, the system 100 may not be generally limited by the particular disparity map generation algorithm.

The comparator 134 generally compares the difference between the calculated disparity value, DISP, against the predetermined reference value, pRef, the result of which, CTRL, is used as an error signal to the control mechanism 110 for the motor, actuator, and the like.

The results, DISP, of the disparity map generator, 130, are compared to the desired reference value. i.e., the parallax reference, pRef, and the difference is generally implemented as the feedback signal, CRTL, by controller and motor subassembly 110 to adjust the camera spacing, IOD. The adjustment subsystem 110 may translate the stereo camera pair 102 closer and farther apart from each other respectively decreasing and increasing the disparity between the two resulting images providing a stereoscopic view having desired disparity to the user when the results, DISP, of the DMG 130 are within the range of the desired parallax reference, pRef.

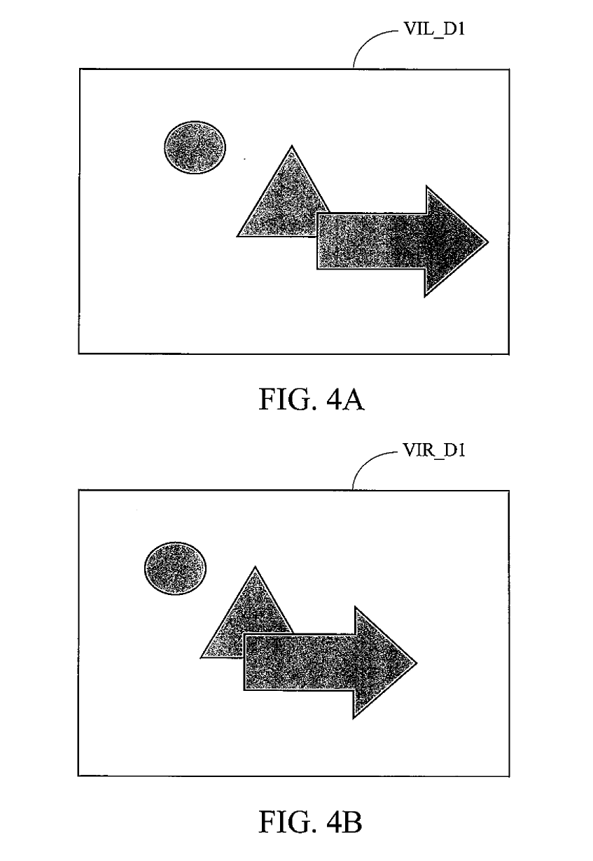

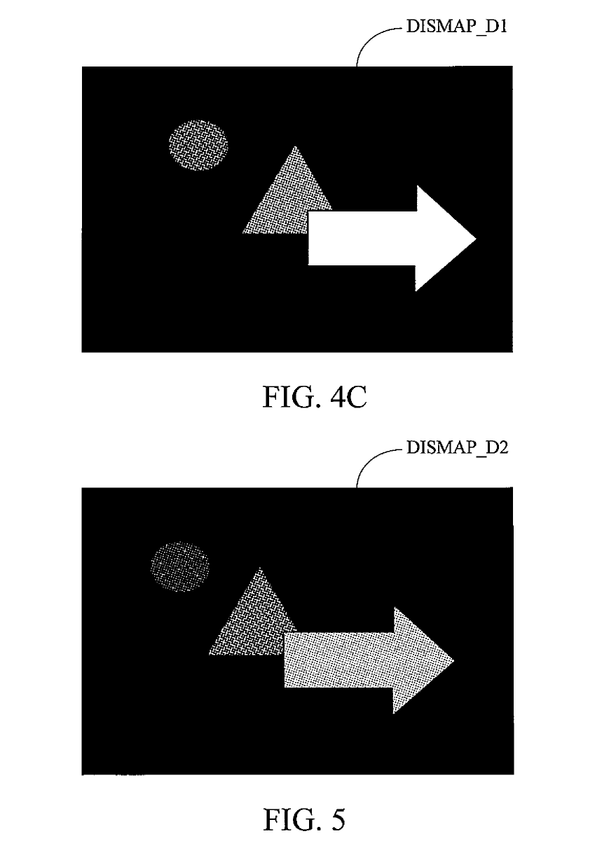

Referring to FIGS. 4(A-C) and 5, FIGS. 4(A-B), are illustrations of the left camera and right camera images (e.g., left camera 102L image VIL_D1 and right camera 102R image VIR_D1) as generated via the system of FIGS. 1 and 3 when the separation of the left camera and right camera, IOD, is at a first distance. FIG. 4C is an illustration of a disparity map, DISMAP_D1, generated via the DMG 130 in response to the camera images, VIL_D1 and VIR_D1 of FIGS. 4(A-B). FIG. 5 is an illustration of a disparity map, DISMAP_D2, generated similarly to the images of FIGS. 4(A-B) when the separation, IOD, of the left camera 102L and right camera 102R is at a second distance.

By processing the images of a scene (e.g., images VIL_D1 and VIL D2 on FIGS. 4A and 4B, respectively) the numerical value for disparity can be assigned a grayscale value for each region within the scene. As described above in connection with FIG. 3, the output signal from the DMG 130, DISP, is the maximum disparity value for the scene. For the scene, DISMAP_D1, the disparity grayscale values range from zero to a maximum of 30 (black to white, respectively). The graphical results of a saturated disparity map, DISMAP_D1, are illustrated on FIG. 4C where the camera spacing, IOD, was more distant than was desired.

As illustrated on FIG. 4C, had the cameras 102L and 102R been spaced closer together when the images, VIL and VIR, were captured, the disparity grayscale values generated would have been lower, as illustrated as DISMAP_D2 on FIG. 5, where the cameras 102L and 102R were positioned at a closer separation, IOD, that was about half of the distance as was used in the generation of the images VIL_D1 and VIR_D1 on FIGS. 4(A-B). The closer spacing that was implemented to provide the grayscale disparity map, DISMAP_D2, resulted in a maximum disparity value of only 9 for the image set, VIL and VIR, that was used to generate FIG. 5. Note also, the disparity map, DISMAP_D2, on FIG. 5 illustrates a grayscale image that was generated when the camera spacing, IOD, was closer than desired.

Note in particular, the difference in grey shading between the arrow shaped element on FIG. 4C and on FIG. 5 where the arrow shaped element is very noticeably darker. While the circle and the triangle shaped elements are darker on FIG. 5 than on FIG. 4C, the difference between the near scene (i.e., SN) object (i.e., the arrow) at the shorter distance (i.e., Np) from the cameras 102 more readily apparent.

With an understanding of the human visual system and empirical data as known to one of ordinary skill in the art to support calculated values, a desirable disparity value (e.g., the reference range, pRef) can generally be determined and controlled via the control (feedback) signal, CTRL, by comparing the results of the disparity map, DISP, to the desired value, pRef, and spacing apart and/or adjusting the angular orientation about the vertical axis the cameras 102 accordingly (i.e., dynamically adjusting the separation, IOD, and/or the angles ANL and ANR in near real time via the electromechanical adjustment subsystem 110).

In one example, when the desired disparity range value, pRef, was determined to be 21, and the cameras 102L and 102R were positioned to generate the disparity map, DISMAP_D1, whose disparity value, DISP, was equal to 30, the apparatus 110 (see, FIG. 3 and related description) would decrease the distance, IOD, between the cameras 102L and 102R such that a matching disparity value, DISP, equal to 21 is generated. Conversely, when the cameras 102L and 102R were positioned to generate the disparity map, DISMAP_D2, whose disparity value, DISP, was equal to 9, the apparatus 110 would increase the distance, IOD, between the cameras 102L and 102R such that a matching disparity value, DISP, equal to 21 is generated.

As objects in the scene change by becoming closer or farther away from the camera set 102L and 102R, in response to the feedback error control signal, CTRL, the controller 110 will generally dynamically change the positions of the cameras cameras 102L and 102R as required to maintain the desired disparity value within the desired range, pRef, with no user intervention involved.

As is apparent then from the above detailed description, the present invention may provide an improved system and an improved method for stereo imagery generation.

Various alterations and modifications will become apparent to those skilled in the art without departing from the scope and spirit of this invention and it is understood this invention is limited only by the following claims.

What is claimed is:

1. A system for generation of stereo video imagery comprising:
a first video camera that generates and presents a first video image signal and having a first optical axis, and a second video camera that generates and presents a second video image signal and having a second optical axis;
an analysis subsystem that receives the first and second video image signals, and generates and presents a control signal;
a mounting rail; and
an electromechanical adjustment subsystem that receives the control signal;
wherein, the first and second video cameras are electromechanically coupled to the mounting rail and the adjustment subsystem such that the first optical axis and the second optical axis are substantially parallel, and lateral positioning of the first and second video cameras on the rail is dynamically adjusted via the electromechanical adjustment subsystem in response to the control signal;
the analysis subsystem comprises a disparity map generator, a reference block that presents a reference parallax signal, and a comparator having a first comparator input and a second comparator input and a comparator output; and the disparity map generator receives the first and second video image signals and generates a disparity signal in response to the first and second video image signals and presents the disparity signal to the first comparator input; and the comparator receives the reference parallax signal at the second comparator input, generates the control signal in response to the difference between the disparity signal and the reference parallax signal, and presents the control signal via the comparator output to the electromechanical adjustment subsystem in near real time to dynamically minimize the difference between the disparity signal and the reference parallax signal.

2. The system of claim 1 further comprising a stereoscopic video display device that receives the first and second video image signals, and presents a stereoscopic video image to a viewer.

3. The system of claim 2 wherein, the first and second video cameras are electromechanically coupled to the mounting rail and the adjustment subsystem such that desired scenery is viewed substantially simultaneously, with the same magnification, field of view, and temporal synchronization.

4. The system of claim 1 wherein, the electromechanical adjustment subsystem provides lateral translation of the first and second video cameras in response to the control signal to adjust the spacing between the first and second video cameras without effect on parallel alignment of the first and second optical axes.

5. The system of claim 4 wherein, the electromechanical adjustment subsystem further provides rotation of the first and second video cameras in response to the control signal to adjust the horizontal angular subtense between the first and second video cameras.

6. The system of claim 1 wherein, the disparity map generator is implemented as a sliding window, block matching stereo correspondence algorithm that determines the disparity signal as a single representative value.

7. The system of claim 1 wherein, the reference block comprises a computer memory that stores and presents one or more of the reference parallax signal.

8. A method of generating stereo video imagery comprising:
electromechanically coupling:
a first video camera that generates and presents a first video image signal and having a first optical axis, and a second video camera that generates and presents a second video image signal and having a second optical axis; wherein, the first optical axis and the second optical axis are substantially parallel;
an analysis subsystem that receives the first and second video image signals, and generates and presents a control signal;
a mounting rail; and
an electromechanical adjustment subsystem that receives the control signal; and
adjusting lateral positioning of the first and second video cameras on the rail dynamically via the electromechanical adjustment subsystem in response to the control signal; wherein,
the analysis subsystem comprises a disparity map generator, a reference block that presents a reference parallax signal, and a comparator having a first comparator input and a second comparator input and a comparator output; and the disparity map generator receives the first and second video image signals and generates a disparity signal in response to the first and second video image signals and presents the disparity signal to the first comparator input; and the comparator receives the reference parallax signal at the second comparator input, generates the control signal in response to the difference between the disparity signal and the reference parallax signal, and presents the control signal via the comparator output to the electromechanical adjustment subsystem in near real time to dynamically minimize the difference between the disparity signal and the reference parallax signal.

9. The method of claim 8 further comprising electrically coupling to the first and second video cameras a stereoscopic video display device that receives the first and second video image signals, and presents a stereoscopic video image to a viewer in response to the first and second video image signals.

10. The method of claim 9 wherein, the first and second video cameras are electromechanically coupled to the mounting rail and the adjustment subsystem such that desired scenery is viewed substantially simultaneously, with the same magnification, field of view, and temporal synchronization.

11. The method of claim 8 wherein, the electromechanical adjustment subsystem provides lateral translation of the first and second video cameras in response to the control signal to adjust the spacing between the first and second video cameras without effect on parallel alignment of the first and second optical axes.

12. The method of claim 11 wherein, the electromechanical adjustment subsystem further provides rotation of the first and second video cameras in response to the control signal to adjust the horizontal angular subtense between the first and second video cameras.

13. The method of claim 8 wherein, the disparity map generator is implemented as a sliding window, block matching stereo correspondence algorithm that determines the disparity signal as a single representative value.

14. The method of claim 8 wherein, the reference block comprises a computer memory that stores and presents one or more of the reference parallax signal.

15. An analysis system for controlling generation of stereo video imagery comprising:
a disparity map generator;
a reference block that presents a reference parallax signal; and
a comparator having a first comparator input and a second comparator input and a comparator output; wherein, the disparity map generator:
receives a first video image signal that is generated and presented by a first video camera having a first optical axis and a second video image signal that is generated and presented by a second video camera and having a second optical axis; and
generates a disparity signal in response to the first and second video image signals and presents the disparity signal to the first comparator input; and the comparator receives the reference parallax signal at the second comparator input, generates a control signal in response to the difference between the disparity signal and the reference parallax signal, and presents the control signal via the comparator output to an electromechanical adjustment subsystemt;
wherein, the first and second video cameras are electromechanically coupled to a mounting rail and the electromechanical adjustment subsystem such that the first optical axis and the second optical axis are substantially parallel, and lateral positioning of the first and second video cameras on the rail is adjusted via the electromechanical adjustment subsystem in response to the control signal in near real time to dynamically minimize the difference between the disparity signal and the reference parallax signal.

16. The system of claim 15 wherein, the first and second video cameras are electromechanically coupled to the mounting rail and the adjustment subsystem such that the first and second video image signals are generated substantially simultaneously, with the same magnification, field of view, and temporal synchronization.

17. The system of claim 15 wherein, the electromechanical adjustment subsystem provides lateral translation of the first and second video cameras in response to the control signal to adjust the spacing between the first and second video cameras without effect on parallel alignment of the first and second optical axes.

18. The system of claim 17 wherein, the electromechanical adjustment subsystem further provides rotation of the first and second video cameras in response to the control signal to adjust the horizontal angular subtense between the first and second video cameras.

19. The system of claim 15 wherein, the disparity map generator is implemented as a sliding window, block matching stereo correspondence algorithm that determines the disparity signal as a single representative value.

20. The system of claim 15 wherein, the reference block comprises a computer memory that stores and presents one or more of the reference parallax signal.
